(19) United States
(12) Patent Application Publication
(10) Pub. No.: US 2017/0196322 A1
(43) Pub. Date: Jul. 13, 2017

(54) CANE ASSEMBLY

(71) Applicant: Kyle Denmark, Fort Worth, TX (US)

(72) Inventor: Kyle Denmark, Fort Worth, TX (US)

(21) Appl. No.: 15/399,463

(22) Filed: Jan. 5, 2017

Related U.S. Application Data
(60) Provisional application No. 62/277,778, filed on Jan. 12, 2016.

(51) Int. Cl. A45B 9/04; A61H 3/00; A45B 9/02

(52) U.S. Cl. CPC A45B 9/04; A45B 9/02; A61H 3/00; A45B 2009/002

(57) ABSTRACT

An assembly and method for the operation and use of a cane assembly is presented. The assembly includes a handle portion configured to selectively adjust in length. A leg assembly is located at the bottom of the cane body and is configured to selectively operate between an open and a closed position, such that when opened, the footprint of the leg assembly increases to provide added stabilization to the cane body. A deployment mechanism is configured to selectively operate a leg assembly.

### CLAIM OF PRIORITY

This application claims the benefit of U.S. Provisional Application No. 62/277,778, filed 12 Jan. 2016. The information contained therein is hereby incorporated by reference.

### BACKGROUND

1. Field of the Invention

The present application relates generally to a cane assembly, and in particular to a cane used to afford the user increased stability by selectively adjusting the footprint of the cane.

2. Description of Related Art

Walking aid may take various forms, such as a walker, crutches, or a cane. They help substitute for a decrease in strength, range of motion, joint stability, coordination, or endurance. When used, they can also reduce the stress on a painful joint or limb. Using a walking aid can help you be more safe and independent in your daily activities. There are many in use today but disadvantages remain.

Walkers are very bulky and bring unwanted attention to the patient in that it is an obvious piece of medical equipment. Crutches are in a similar situation to that of walkers. They are more limited in their use and are more difficult to handle by the patient. Canes on the other hand are less bulky and more applicable to patients across all ages. However, canes themselves have some drawbacks.

Canes are typically a single “stick” like body that includes a handle end and a rubber or gripping end that contacts the ground. As the patient walks, they place weight upon the cane. However, when not in use, canes must be propped against a wall or other object or laid on the ground. Canes often slide and fall when propped up. It is important that the cane remain in reachable proximity to the user to ensure mobility. It can be very difficult for a user to bend over or reach the cane when it is fallen to the ground. Some canes try to alleviate this issue by forming a permanently attached base that has typically 4 legs. These bases make some users feel older and more disabled than they perceive themselves to be. Additionally, they are not designed to adapt to the conditions or needs of the user during treatment.

Another disadvantage of conventional canes is that they are of a set diameter. The footprint of the cane remains the same. A gap exists between the treatment and use of a walker to that of transitioning to a cane. A walker provides a considerable amount of stability for the user. A cane, however, is limited in the degree of stability provided. Canes fail to provide various degrees of stability to adjust to the needs of the user over time.

Although great strides have been made with respect to various walking aids, considerable shortcomings remain. A new cane assembly is needed that provides the ability for varied stability assistance and can stand freely in a vertical orientation without external assistance.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a perspective view of a cane assembly according to an embodiment of the present application.

FIG. 2 is an alternate perspective view of the cane assembly of FIG. 1 where a leg assembly is activated.

FIGS. 3-5 are assorted side views of a body of the cane assembly of FIGS. 1 and 2.

FIG. 6 is an enlarged side view of a sleeve within a deployment mechanism in the cane assemblies of FIGS. 1 and 2.

FIG. 7 is an enlarged side view of a base of the body of FIGS. 1 and 2.

FIG. 8 is a side section view of the cane assembly of FIG. 1.

FIG. 9 is an enlarged side view of a deployment mechanism in the cane assembly of FIG. 8.

FIG. 10 is an enlarged side section view of a leg assembly of the cane assembly of FIG. 8.

FIG. 11 is a side section view of the cane assembly of FIG. 2.

FIG. 12 is an enlarged side view of a deployment mechanism in the cane assembly of FIG. 11.

FIG. 13 is an enlarged side section view of a leg assembly of the cane assembly of FIG. 11.

FIG. 14 is a bottom view of the leg assembly of FIG. 13.

While the assembly and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The assembly and method in accordance with the present application overcomes one or more of the above-discussed problems commonly associated with conventional walking canes. Specifically, the cane assembly of the present application is configured to include selectively deployable stabilizing legs to permit users to stand the cane upright when not in use. Additionally, the cane assembly is configured to utilize the deployable legs to assist patients during a recovery wherein the legs deploy to various different widths for increasing stability when walking. The cane assembly is also designed to be clean and streamlined to avoid the appearance of a medical device. These and other unique features of the device are discussed below and illustrated in the accompanying drawings.

The assembly and method will be understood as to its operation, from the accompanying drawings, taken in conjunction with the accompanying description. It should be understood that various components, parts, and features of the device may be combined together and/or interchanged with one another, all of which are within the scope of the present application, even though not all variations and particular embodiments are shown in the drawings. It should also be understood that the mixing and matching of features, elements, and/or functions is expressly contemplated herein so that one of ordinary skill in the art would appreciate from this disclosure that the features, elements, and/or functions of one embodiment may be incorporated into another embodiment as appropriate, unless otherwise described.

The assembly and method of the present application includes a central body, a handle portion, and a mechanism for deploying a plurality of legs. The central body is configured to house the deployment mechanism. The legs are pivotally coupled to the central body and operate as designed with the deployment mechanism. The handle is adjustable in length and translates coaxially with the central body. The telescoping nature of the handle portion permits the user to adjust the overall length of the cane assembly to accommodate height variations. As an assembly, the cane assembly selectively provides the user control over the amount of stability available during use and for a simple and effective way to store the cane upright.

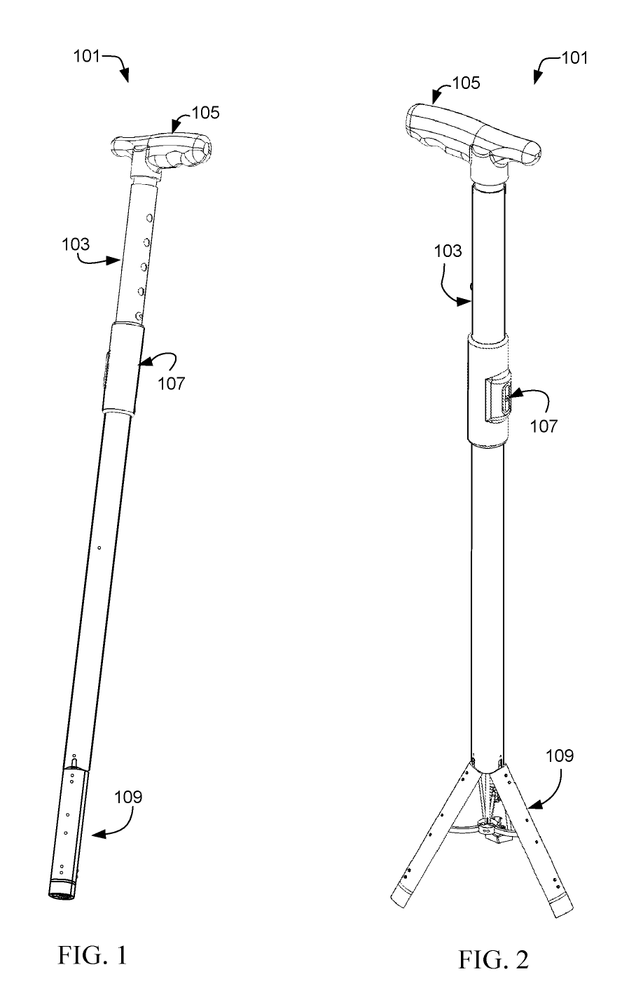

Referring now to FIGS. 1 and 2 in the drawings, a cane assembly 101 is illustrated. Cane assembly 101 includes a central body 103 handle portion 105, a deployment mechanism 107, and a leg assembly 109. Cane assembly 101 is configured to selectively permit a user to broaden the footprint of the cane so as to increase stability. Leg assembly 109 is configured to operate between an open and a closed position. Deployment mechanism 107 is configured to selectively operate the leg assembly between those two positions. Operation of leg assembly 109 stabilizes central body 103 in an upright position by broadening the footprint of leg assembly 109.

FIG. 1 shows cane assembly 101 with leg assembly 109 in a closed position. FIG. 2 shows cane assembly 101 with leg assembly 109 in an open position. Deployment mechanism 107 is configured to grant the user control of positioning leg assembly 109. Portions of deployment mechanism 107 may translate relative to central body 103 during operation.

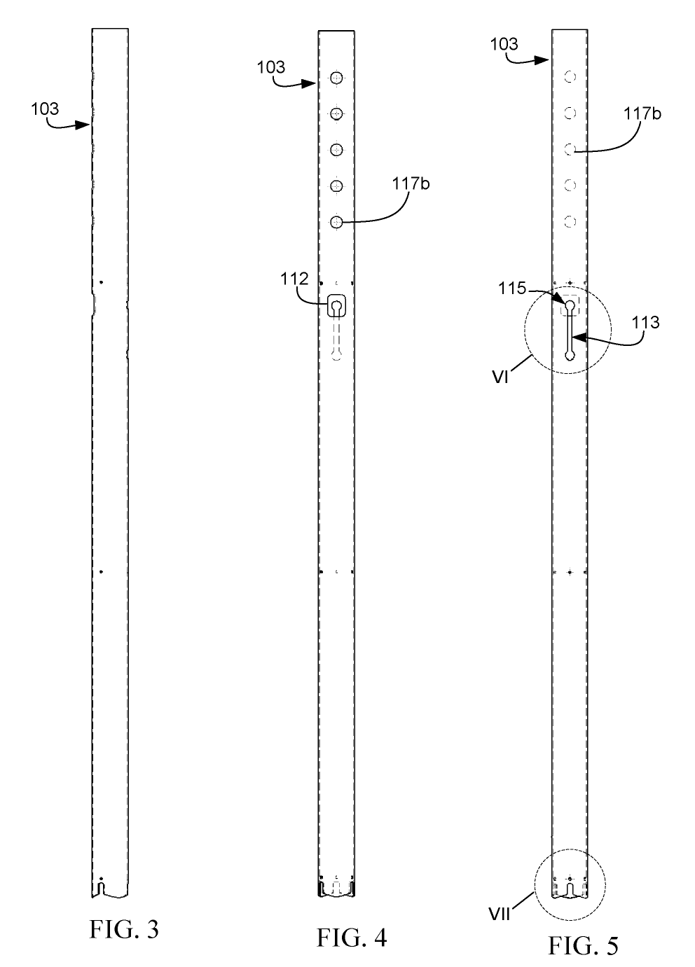

Referring now also to FIGS. 3-7 in the drawings, central body 103 is illustrated in a number of side views. Central body 103 is used to house portions of handle portion 105, mechanism 107, and potentially even portions of leg assembly 109. Body 103 is hollowed out to varying internal diameters along its length. Body 103 further includes a slot 113 and notches 112 and 115. Such are used in the operation of mechanism 107 in order to deploy leg assembly 109. In particular, notch 112 provides access to the central volume of body 103 to maintain mechanism 107.

Body 103 may be made from various different materials and is not limited to any particular type. It is conceived that the best materials will be dependent upon design and budget constraints but will typically be those materials that are strong and lightweight. It is understood that all portions of cane assembly 101 have similar freedoms with regard to material selection. It is also conceived that assembly 101 may be selectively weighted to adjust the center of gravity of the cane to a desired position.

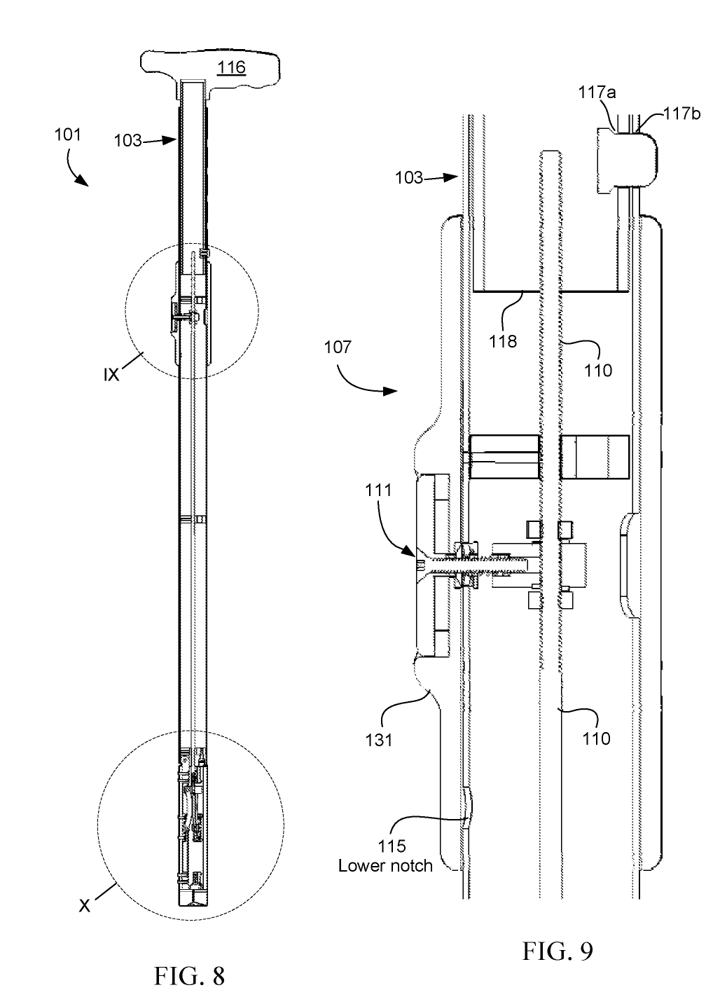

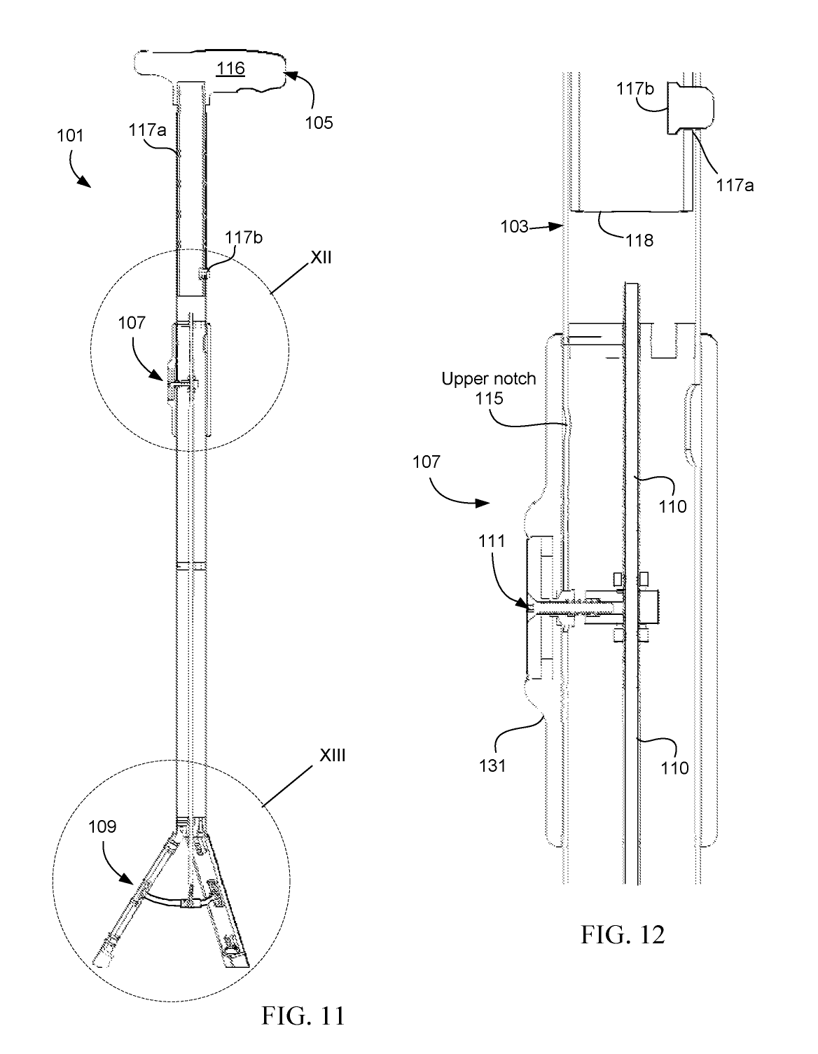

Handle portion 105 translates within body 103. Handle portion 105 is designed and contoured for the comfortable ergonomic gripping of the user. In particular, handle portion 105 includes a handle 116 for just such purpose (see FIGS. 8 and 11). Handle 116 is coupled to a shaft 118 that includes an aperture 117a (see in greater clarity in FIGS. 9 and 12). Aperture 117a is designed to selectively align with one or more apertures 117b in body 103. A biased pin 120 is coupled to aperture 117a and is biased between a retracted position and an extended position. When extended, pin 120 extends through aperture 117a and any of apertures 117b, thus while pin 120 is retracted, shaft 118 translates within body 103 until a suitable alignment is made. When pin 120 is extended, translation of shaft 118 is restrained.

Adjustment of pin 120 is permitted in accordance with the needs and size of the user. It is understood that the overall working height of cane assembly 101 may be changed as the legs 108 deploy. The operation of handle portion 105 is useful to help correct for changes in relative cane length. For example, it is understood that legs 108 may be deployed to one or more radial positions thereby increasing and decreasing the relative diameter of legs 108, collectively. As legs 108 change between a closed position and any open position, the overall functioning height from handle 116 to the ground can change. A user may choose to adjust the positioning of handle 116 between deployment positions. As a user gains more stability over time, leg assembly 109 may be opened less and less thereby allowing for the position of handle portion 105 to be more constant. A feature of cane assembly 101 is that as the stability of the user improves or degrades over time, the stability and the relative height of the overall cane can be adjusted as necessary.

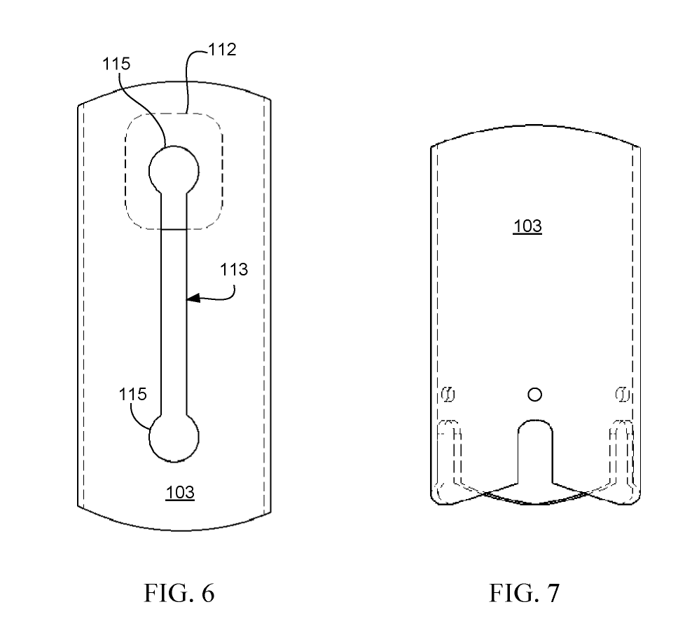

As seen in particular with FIG. 6, slot 113 and notches 115 are illustrated in greater detail. Slot 113 and notches 115 are configured to be used in operation with mechanism 107, to operate leg assembly 109. As seen in FIG. 7, a base portion of body 103 is illustrated in an enlarged view. Leg assembly 109 engages portions of body 103 and is configured to extend out away from its central axis. Spacing is formed into body 103 to allow for the pivoting of legs 108.

Referring now also to FIGS. 8-14 in the drawings, wherein selected section views related to both FIGS. 1 and 2 are illustrated. As noted previously, FIG. 1 shows assembly 101 with leg assembly in a closed position. FIGS. 8-10 provide section views of assembly 101 with leg assembly 109 in the closed position. Likewise, FIGS. 11-14 illustrate section views of assembly 101 wherein leg assembly 109 is in an open position. Such views correspond with FIG. 2. Discussion of FIGS. 8-14 will be done simultaneously in an effort to show the operation of assembly 101.

As seen in FIGS. 9 and 12, Mechanism 107 is illustrated. Mechanism 107 is configured to operate leg assembly 109. Mechanism 107 includes a control rod 110 and a depressor 111. Control rod 110 is configured to pass within a portion of central body 103 from mechanism slot 113 to leg assembly 109. Rod 110 acts as the link. As depressor 111 is activated and operated, control rod 110 translates within central body 103. The control rod 110 is operably coupled to portions of legs 108, such that movement of rod 110 results in the operation of legs 108. One or more bushings may be provided to maintain the alignment of rod 110 with that of body 103.

Operation of rod 110 is performed through a depressor in the present application. A spring-loaded depressor 111 is in communication with the control rod 110. Central body 103 is configured to have slot 113 with a plurality of notches 115. Depressor 111 is operated such that, when depressed, the diameter of depressor 111 is small enough to permit the translation of depressor 111 within slot 113, between notches 115. When the particular notch 115 is achieved, depressor 111 is released and depressor 111 is biased outward such that depressor 111 now engages notch 115 (either upper or lower) with a greater diameter unpassable through slot 113. Each notch position corresponds to a particular leg position. In FIG. 9, depressor 111 is located in the upper notch 115. In FIG. 12, depressor 111 is located in the lower notch 115. A sleeve 131 around body 103 is had to support and house depressor 111. Sleeve 131 is configured to translate with depressor 111 between notches 115.

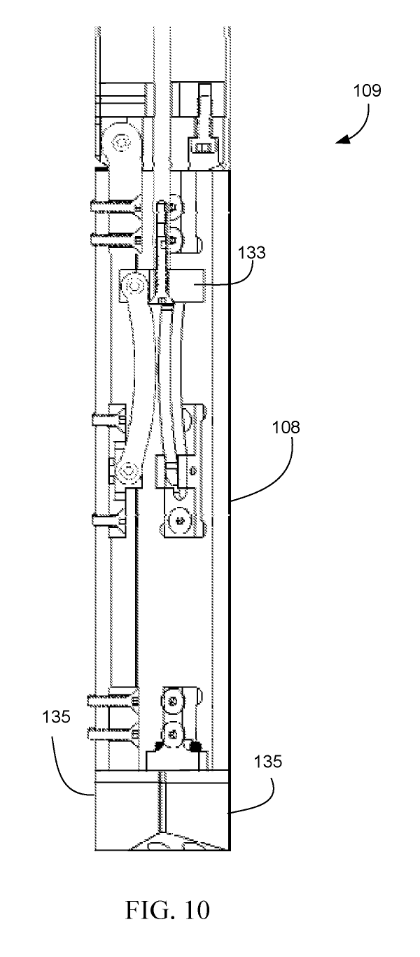

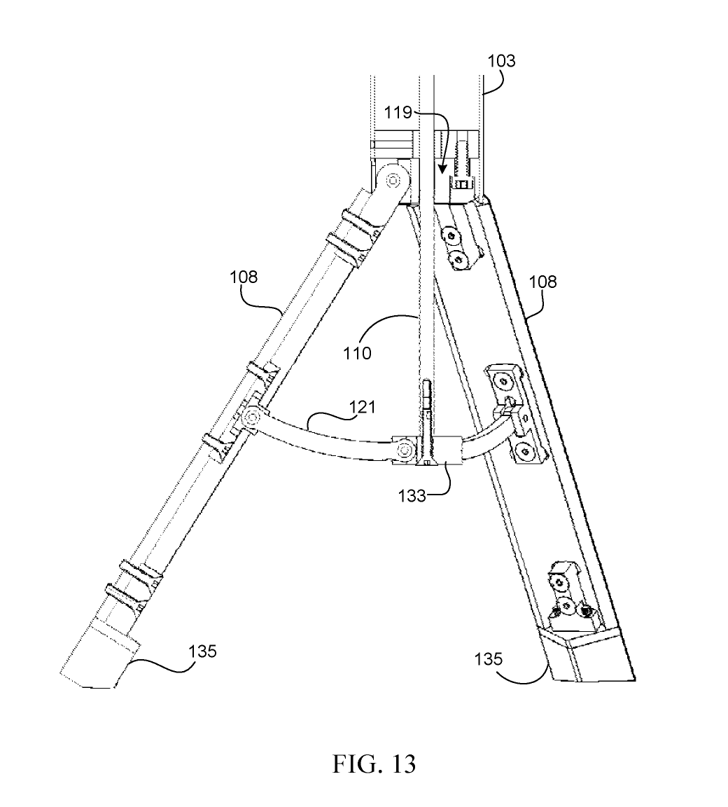

Referring now in particular to FIGS. 10 and 13 in the drawings, leg assembly 109 is shown in greater detail. Selected section views are provided. Leg assembly 109 includes one or more legs 108. When closed, legs 108 are configured to retract and store so as to be flushly mounted and parallel to that of the outer surface of body 103. Together, legs 108 create a whole tubular shape similar in size and shape to body 103. The number of legs determine the particular size or radial length of each leg. Ideally each leg is identical in size, but varied sizing is also contemplated.

FIG. 13 shows leg assembly in an open position. Legs 108 are configured to provide varied levels of stability to the user depending on their position. To ensure that legs 108 stay aligned when retracted, body 103 may include a formed track 119 along a surface adjacent legs 108. When extended, legs 108 pivot along body 103 at an upper end. Control rod 110 is coupled to legs 108 via one or more supports 121. A base member 133 acts as the intermediary member between rod 110 and supports 121. Rod 110 may be adjustable relative to base member 133 (i.e. threadedly). Supports 121 are pivotally coupled to member 133. As mechanism 107 is operated, control rod 110 translates within body 103 between varied degrees of extension for the legs. When supports 121 are horizontal, legs 108 are at their outer most extension. This position may correspond to the lowest notch 115 on body 103. As control rod 110 is retracted into body 103, supports 121 pull legs 108 inward toward a parallel alignment with body 103. Proper adjustment of rod 110 will ensure legs 108 are pulled inward sufficiently to avoid wobble.

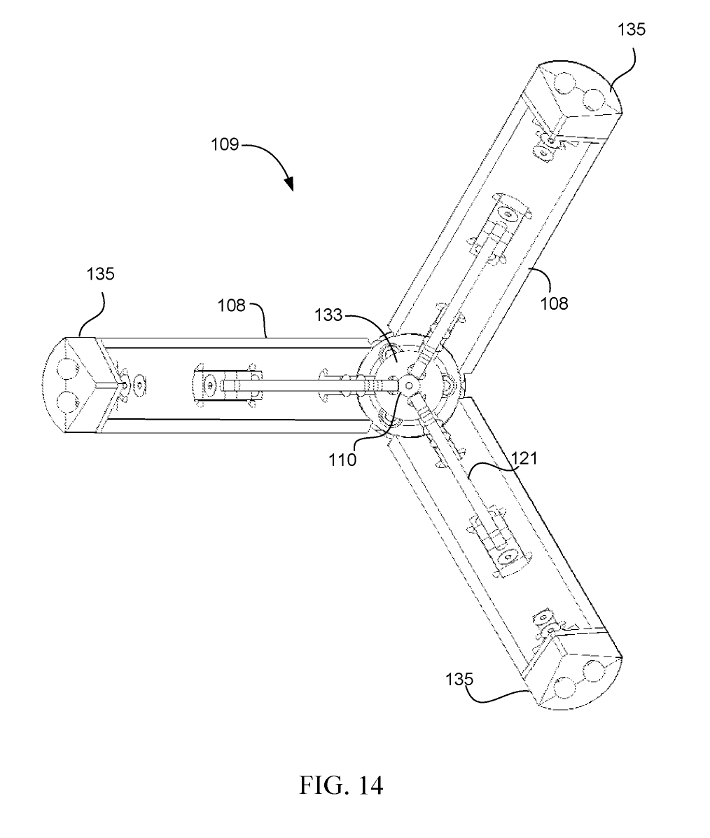

FIG. 14 is illustrated to provide an additional view of leg assembly 109. The numerical identifiers used in FIG. 13 correspond to those found in FIG. 14. It is understood that legs 108 may optionally include one or more feet 135. Feet 135 are configured to increase friction between assembly 101 and the ground. An example of feet 135 may be a detachable rubber member. Other items are contemplated.

Naturally it is conceived that the particular embodiments of assembly 101 are not herein limited as shown and described. The use of control rod 110 and supports 121 may function differently. Furthermore, mechanism 107 may be operable in various different ways. Ultimately, assembly 101 is configured to provide a user with increased and customizable stability. Assembly 101 helps to bridge the gap between the use of a walker and a cane. Additionally, assembly 101 is configured to stand uprightly in an unassisted manner when legs 108 are deployed. In this way, the user is able to maintain better access to the cane. Assembly 101 includes a number of other advantages.

The current application has many advantages over the prior art including at least the following: (1) adjustable height cane handle; (2) simple and quick to use deployment mechanism; (3) a cane body having a variable base footprint; and (4) adapted to meet the needs of a user through rehabilitation, or as medical conditions change over time.

The particular embodiments disclosed above are illustrative only and are not intended to be exhaustive or to limit the invention to the precise form disclosed, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A cane assembly, comprising:
a handle portion;
a leg assembly configured to operate between an open and a closed position;
a deployment mechanism configured to selectively operate the leg assembly; and
a central body in communication with the leg assembly, the handle portion, and the deployment mechanism;
wherein operation of the deployment mechanism stabilizes the central body in an upright position by broadening the footprint of the leg assembly.

2. The assembly of claim 1, wherein the handle portion is ergonomically contoured for increased comfort.

3. The assembly of claim 1, wherein the position of the handle portion is adjustable.

4. The assembly of claim 1, wherein the handle portion includes a shaft which translates within the central body.

5. The assembly of claim 1, wherein the position of the handle portion is selectable via the operation of a bias pin.

6. The assembly of claim 1, wherein the leg assembly is in communication with the deployment mechanism through a control rod.

7. The assembly of claim 1, wherein the deployment mechanism is operable between an upper and lower position.

8. The assembly of claim 1, wherein the deployment mechanism translates along the central body.

9. The assembly of claim 1, wherein the deployment mechanism includes a depressor configured to pass through a slot in the central body.

10. The assembly of claim 1, wherein the central body includes a slot for the operation of the deployment mechanism.

11. The assembly of claim 1, wherein the leg assembly is operable between a plurality of open positions.

12. The assembly of claim 1, wherein the leg assembly is configured to adjust the stability of the cane assembly so as to assist in treatment of the user.
